(19) United States
(12) Patent Application Publication
(10) Pub. No.: US 2026/0181373 A1
(43) Pub. Date: Jun. 25, 2026

(54) MANAGING ROAMING DATA TRAFFIC ANOMALIES IN TELECOMMUNICATIONS NETWORKS

(71) Applicant: T-Mobile USA, Inc., Bellevue, WA (US)

(72) Inventors: Manoj Bhatt, Redmond, WA (US); Daniel David Curry, Bothell, WA (US); John Barry Santiago Lazarte, Tukwila, WA (US); June Allan O. Malit, Renton, WA (US)

(21) Appl. No.: 18/990,343

(22) Filed: Dec. 20, 2024

(51) Int. Cl. H04W 8/02; H04L 41/06

(52) U.S. Cl. CPC H04W 8/02; H04L 41/06

(57) ABSTRACT

A method for managing roaming data traffic in a network includes accessing roaming data records comprising data traffic volume information by multiple wireless devices accessing networks different from the network. The roaming data records represent a period of time and are associated with multiple countries and roaming network operators. The method includes determining country-specific deviation values describing data traffic volume deviating from average volumes, determining whether these values satisfy a threshold range, and categorizing countries exceeding the threshold as outlier countries. For outlier countries, operator-specific deviation values are determined for each roaming network operator. Upon determining a particular roaming network operator is associated with an anomaly, the method enables performing a mitigating action including steering of roaming within network operators of the particular country to correct the anomaly.

### BACKGROUND

Wireless network operators provide roaming services that allow their subscribers to access wireless networks in other countries through partnerships with foreign operators. These roaming arrangements enable subscribers to maintain connectivity while traveling internationally by connecting to partner networks, with the home operator managing authentication, billing, and data services through interconnection agreements. The roaming traffic flows through network elements like packet gateways that facilitate data exchange between the visited and home networks. Network operators can monitor and analyze roaming traffic patterns across hundreds of international partners to maintain service quality and manage network resources.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a roaming network infrastructure network according to some implementations of the disclosed technology.

FIG. 4 is an illustration of a graphical user interface (GUI) for management of roaming data traffic network according to some implementations of the disclosed technology.

FIG. 5 is a flow chart that illustrates a process for management of roaming data traffic network according to some implementations of the disclosed technology.

FIG. 6 is a block diagram that illustrates an example of a computer system in which at least some operations described herein can be implemented.

FIG. 7 is a block diagram that illustrates an example of an artificial intelligence (AI) system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

As global mobile traffic continues to grow, monitoring and managing roaming data across more than 650 roaming operators worldwide is becoming increasingly complex and time-consuming. Conventionally, roaming data is obtained periodically and processed into records that can be reviewed by an operator. Such processes are time-consuming and cause delays in the detection and mitigation of anomalies and discrepancies, such as identifying network issues, capacity constraints, and performance degradation. The delays can decrease the satisfaction of customers using roaming data and/or increase the loss of revenue. There is a need for a centralized tool that provides an efficient manner to evaluate roaming data traffic deviations across roaming operators globally and enables the performance of mitigation actions to address any anomalies in the traffic deviations proactively.

The present technology relates to managing roaming data traffic across multiple countries and network operators and detecting and mitigating the effects of anomalies in such roaming data traffic. The disclosed technology provide management of the roaming data traffic by accessing roaming data records that include information on data traffic volume by multiple wireless devices across different countries and roaming network operators. The roaming data records are used for determining country-specific and operator-specific deviation values to identify outlier countries and roaming operators associated with anomalies within the outlier countries. The disclosed technology also includes providing a graphical user interface (GUI) illustrating the deviation values for efficient visual review and evaluation. Further, mitigating actions can be performed to correct any identified anomalies, for example, by steering roaming between the network operators of the affected country. The steering can include causing wireless devices accessing a roaming network operator associated with an anomaly to access other roaming network operators of the particular country. Further, artificial intelligence (AI) models can be used to validate and predict anomaly detection and identification of the present technology and to provide suggestions for mitigating actions.

The disclosed technology can enable proactive network management, cost-efficient roaming data traffic steering, and enhanced service by facilitating improved decision-making and efficient management of roaming data traffic. For example, the time between performing mitigating actions from the occurrence of an anomaly can be reduced to a day while, with conventional methods, such time required to perform mitigating actions would be a week. Such proactive network management can improve network performance and performance when customers are using roaming wireless access (e.g., in a foreign country), leading to increased customer satisfaction and operational cost savings.

In one example implementation of the disclosed technology, a computer-implemented method for managing roaming data traffic in a telecommunications network includes accessing roaming data records. The roaming data records include information of data traffic volume by multiple wireless devices associated with a service provider of the telecommunications network accessing any wireless networks that are different from the telecommunications network. The roaming data records represent a period of time. The roaming data records are associated with multiple countries and multiple roaming network operators of each of the multiple countries. The method includes determining, using the roaming data records for the period of time, country-specific deviation values for each of the multiple countries. The country-specific deviation values describe data traffic volume deviating from an average data traffic volume for each of the respective countries. The method includes determining, whether each of the country-specific deviation values is above or below a deviation threshold range. Responsive to a determination that a particular country-specific value associated with a particular country is above or below the deviation threshold range, the method includes categorizing the particular country as an outlier country. The method also includes determining, using the roaming data records for the multiple roaming network operators, operator-specific deviation values for each roaming network operator of the particular country. The method also includes providing a graphical user interface (GUI) including a first GUI map portion and a second GUI portion. The second GUI portion includes a geographical illustration of the particular country and one or more of the multiple countries over the period of time. The particular country identified as an outlier country is identified with an indication on the geographical illustration. The bar graph illustrates data traffic volume for each roaming network operator of the particular country. The method further includes determining, using the operator-specific deviation values for each roaming network operator of the particular country, that a particular roaming network operator is associated with an anomaly. Responsive to a determination that the particular roaming network operator is associated with the anomaly, the method includes enabling performance of a mitigating action including steering roaming to correct for the anomaly. Steering the roaming can include causing wireless devices accessing the particular roaming network operator to instead access other roaming network operators of the particular country.

In another example, a system for managing roaming data traffic in a telecommunications network includes at least one hardware processor and at least one non-transitory memory storing instructions, which, when executed by the at least one hardware processor, cause the system to obtain roaming data records. The roaming data records include information of data traffic volume by multiple wireless devices associated with a service provider of the telecommunications network accessing any wireless networks that are different from the telecommunications network. The roaming data records are associated with multiple countries and multiple roaming network operators of each of the multiple countries. The system determines, using the roaming data records, country-specific deviation values for each of the multiple countries. The country-specific deviation values describe data traffic volume deviating from an average data traffic volume for each of the respective countries. The system determines whether each of the country-specific deviation values is above or below a deviation threshold range. Responsive to a determination that a particular country-specific value associated with a particular country is above or below the deviation threshold range, the system categorizes the particular country as an outlier country. The system determines, using the roaming data records for the multiple roaming network operators, operator-specific deviation values for each roaming network operator of the particular country. The system determines, using the operator-specific deviation values for each roaming network operator of the particular country, that a particular roaming network operator is associated with an anomaly. Responsive to a determination that the particular roaming network operator is associated with the anomaly, the system enables performance of a mitigating action to correct for the anomaly.

In yet another example, a system obtains roaming data records. The roaming data records include information of data traffic volume by multiple wireless devices associated with a service provider of a telecommunications network accessing any wireless networks that are different from the telecommunications network. The roaming data records are associated with multiple countries and multiple roaming network operators of each of the multiple countries. The system determines, using the roaming data records, country-specific deviation values for each of the multiple countries. The country-specific deviation values describe data traffic volume deviating from an average data traffic volume for each of the respective countries. The system determines whether each of the country-specific deviation values is above or below a deviation threshold range. Responsive to a determination that a particular country-specific value associated with a particular country is above or below the deviation threshold range, the system categorizes the particular country as an outlier country. The system determines, using the roaming data records for the multiple roaming network operators, operator-specific deviation values for each roaming network operator of the particular country. The system determines, using the operator-specific deviation values for each roaming network operator of the particular country, that a particular roaming network operator is associated with an anomaly. Responsive to a determination that the particular roaming network operator is associated with the anomaly, the system enables a performance of a mitigating action to correct for the anomaly.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

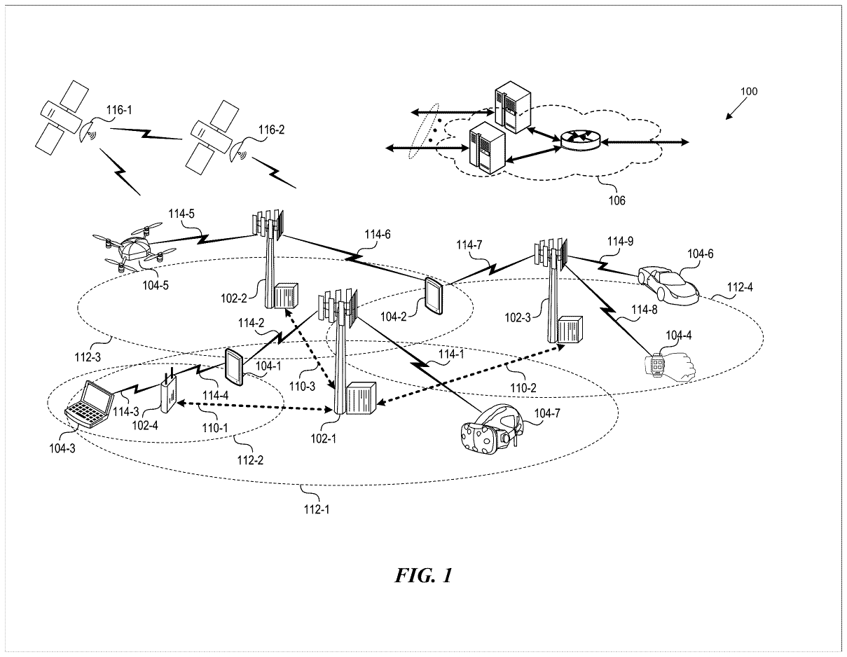

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-7 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

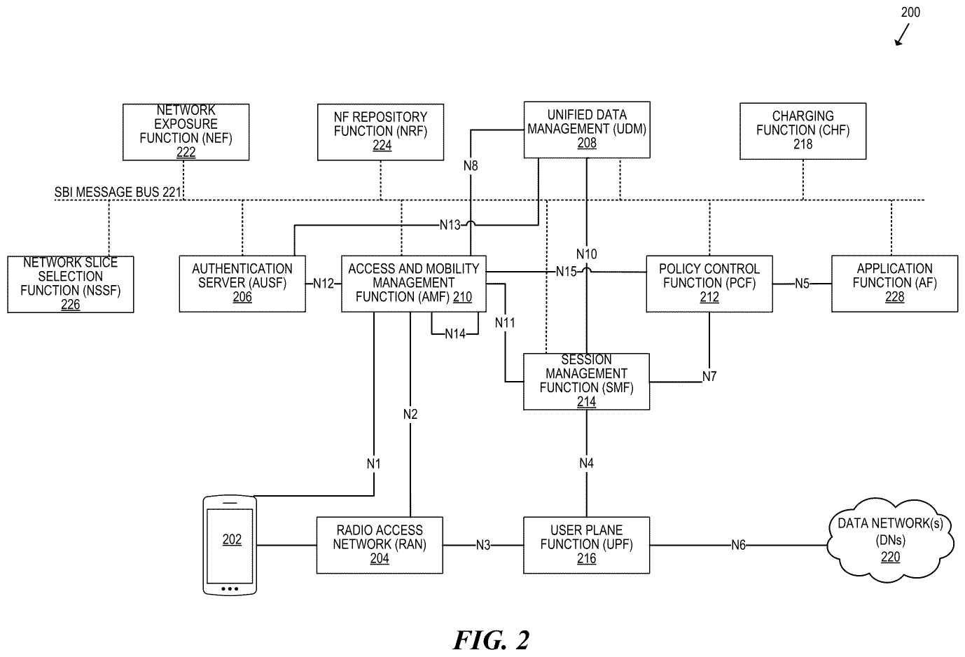

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Management of Roaming Data Traffic

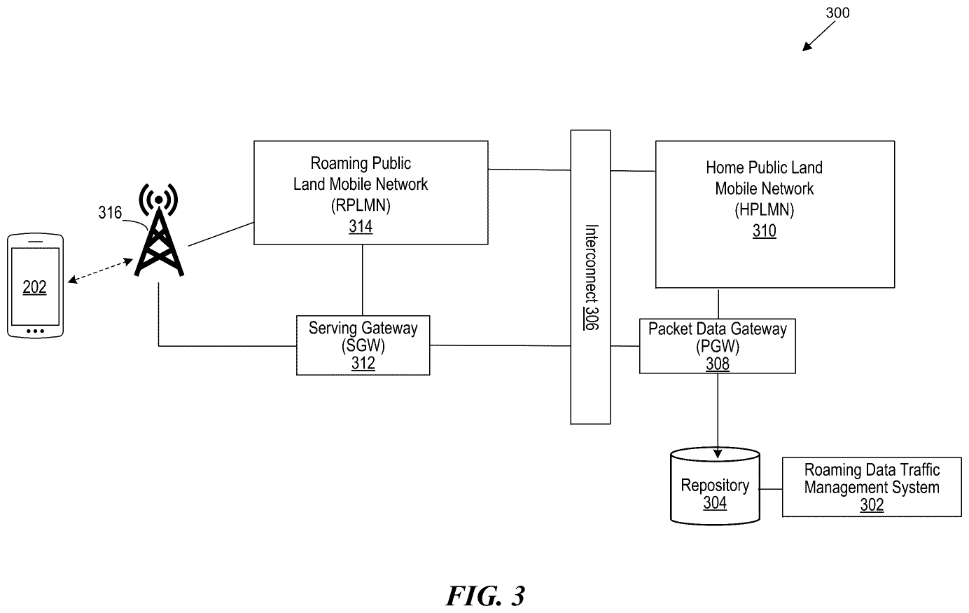

FIG. 3 is a block diagram that illustrates a roaming network infrastructure 300. The infrastructure 300 includes a home public land mobile network (HPLMN) 310 (e.g., associated with the network 100 in FIG. 1) and a roaming public land mobile network (RPLMN) 314 in communication with each other via an interconnect 306.

The RPLMN 314, also referred to as a roaming network operator, can provide network services in a geographical area that is different from the geographical area covered by the HPLMN 310. The RPLMN 314 can be, for example, located in a different country than the HPLMN 310. A roaming network operator, such as the RPLMN 314, can be a foreign network operator that has a roaming agreement with a service provider for a telecommunications network (e.g., the HPLMN 310) or otherwise allows wireless devices associated with the service provider of the telecommunications network to use their network services by roaming. The roaming can be charged from the service provider of the telecommunications network (e.g., based on services used).

The interconnect 306 is configured to facilitate the connectivity and communication between the HPLMN 310 and the RPLMN 314 so that wireless devices (e.g., the device 202) associated with the HPLMN 310 can access and use wireless network services while located in the geographical area of RPLMN 314. The interconnect 306 can facilitate the exchange of signaling and user data, enabling services such as voice, SMS, and data to be accessed by roaming devices.

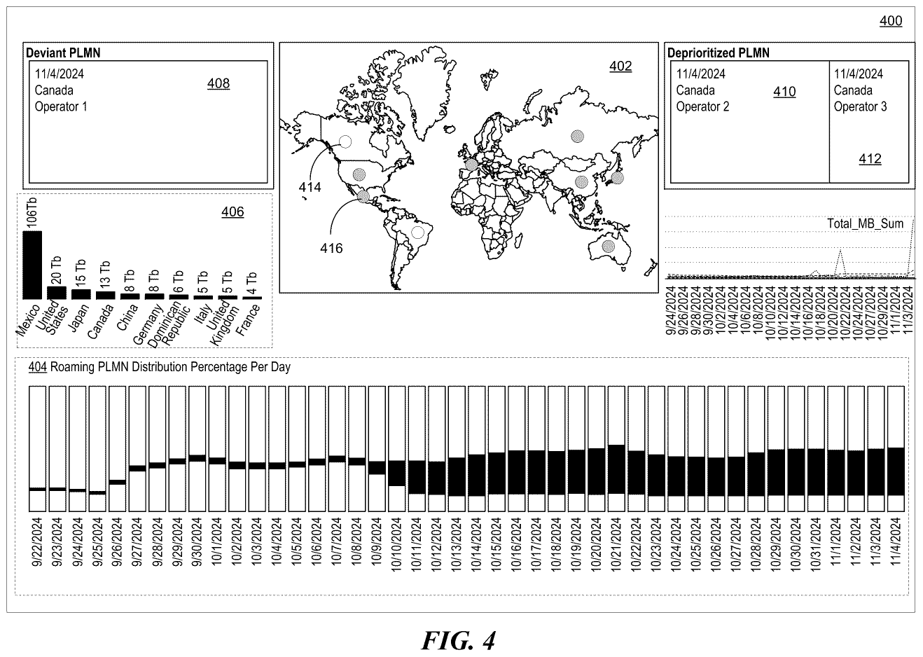

RPLMN 314 is in communication with, or includes, a serving gateway (SGW) 312, and the HPLMN 310 is in communication with, or includes, a packet data gateway (PGW) 308. The SGW is configured to manage telecommunications sessions within the RPLMN 314. The SGW 312 can route and forward user data packets (e. g, Internet protocol (IP) packets) while maintaining the data paths between roaming base stations (e.g., a base station 316 associated with the RPLMN 314) and the PGW 308. Such transfer of data packets can facilitate the transfer of data to and from wireless devices to facilitate data services. The SGW 312 can also transmit to the PGW 308 roaming data describing the data traffic volume used by wireless devices (e.g., the device 202) associated with the HPLMN 310 in the RPLMN 314. The PGW 308 receives the roaming data and further transmits the data to a repository 304 (e.g., the roaming data is stored at the repository 304). The roaming data can be accessed by a roaming data traffic management system 302. For example, the roaming data traffic management system 302 retrieves the roaming data from the repository 304. In some implementations, the roaming data is received by the PGW 308 periodically (e.g., daily or hourly). The roaming data traffic management system 302 is configured to manage the roaming data traffic. Management of the roaming data traffic can include detecting any deviations or anomalies in roaming data traffic in foreign countries and among roaming network operators. The roaming data traffic management system 302 can further be configured to provide a GUI for visualization and management of the roaming data traffic, as described with respect to FIG. 4.

In FIG. 3, the infrastructure 300 illustrates the HPLMN 310 in communication with one RPLMN 314. However, in some implementations, the infrastructure 300 includes multiple RPLMNs in communication with the HPLMN 310 via one or more interconnects 306. The RPLMNs can be associated with different roaming operators from multiple different countries. The PGW 308 can receive the roaming data from multiple SGWs of different RPLMNs and transmit that roaming data to the repository 304. The roaming data traffic management system 302 can be configured to manage the roaming data across multiple roaming operators from multiple different countries.

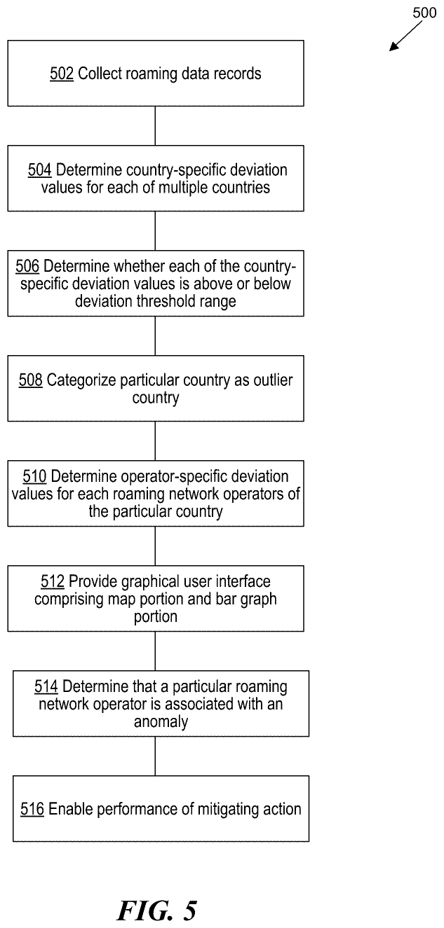

FIG. 4 illustrates a graphical user interface (GUI) 400 for management of roaming data traffic. The GUI 400 is configured to provide a visualization of roaming data traffic that enables a user to efficiently review data traffic flow in multiple countries. The GUI 400 displays data that has been accesses and processed in accordance with a process 500 described with respect to FIG. 5. In particular, the GUI 400 is configured to provide a visualization of identified outlier countries having roaming data traffic that deviates from an average (e.g., mean) data traffic (as evaluated for a period of time).

The GUI 400 includes a map portion 402, graphical data portions 404 and 406, and data display portions 408 and 410. The map portion 402 includes an illustration of a map including multiple countries that include roaming network operators. The different countries might be indicated with an indicator (e.g., indicators 414 and 416) describing whether a country has been identified to have a deviation in the roaming data traffic. Identifiers having a different appearance (e.g., shape, color, pattern) can be used for different countries of different categories. For example, a country identified to be an outlier (e.g., deviating from an average data traffic flow above or below a threshold value) can be indicated with a first appearance of an indicator (e.g., the indicator 414 for Canada is patterned) and a country not identified as an outlier can have a second appearance (e.g., the indicator 416 for Mexico is solid). A user can click on an area of the map portion 402 (e.g., the indicator or the country illustration) to view data associated with different roaming network operators of a country. For example, as shown, data portions 408, 410, and 412 include data associated with three different operators of Canada. The graph portion 404 includes a bar graph illustrating the roaming data volume associated with each of the three Canadian operators per day for a prior time period (e.g., 45 days). The graph portion 404 can provide an easy visualization of relative changes in the roaming data traffic among the different roaming network operators. The graph portion 406 further provides a summary of countries having highest roaming data volumes for the prior time period (e.g., the highest being Mexico).

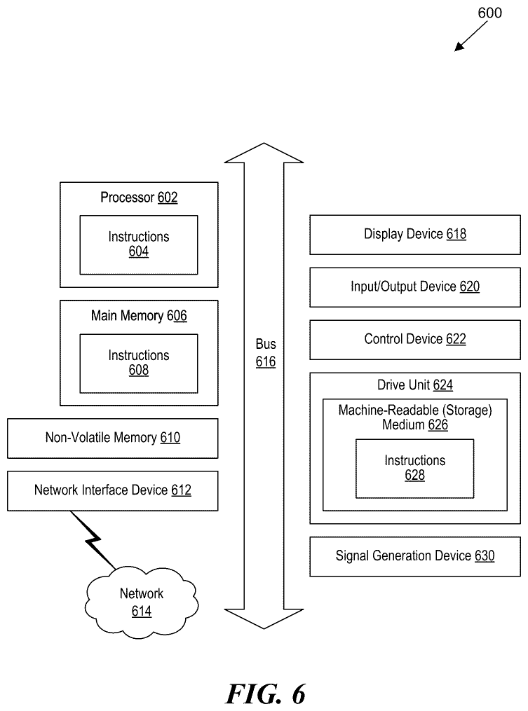

FIG. 5 is a flow chart that illustrates a process 500 for management of roaming data traffic. The processes can be performed by a system (e.g., the system 302 in FIG. 3) associated with a telecommunications network service provider (e.g., a service provider of the network 100 in FIG. 1). The system can include at least one hardware processor and at least one non-transitory memory storing instructions (e.g., a computer system 600 described with respect to FIG. 6). When the instructions are executed by the at least one hardware processor, the system performs the process 500.

The process 500 is directed to management of roaming data traffic and, specifically, identifying outlier countries and anomalies within roaming network operators and enabling performance of mitigating actions to address such anomalies. The process 500 can enable proactive network management, efficient traffic routing, and enhanced roaming service by improving decision-making and efficient management of roaming data traffic. This can lead to better network performance and customer satisfaction as well as operational cost savings.

At 502, the system can access roaming data records (e.g., as described with respect to FIG. 3). The roaming data records can include information of data traffic volume by multiple wireless devices associated with a service provider of the telecommunications network accessing any wireless networks that are different from the telecommunications network. The roaming data records can represent data collected periodically (e.g., every few hours, half a day, day, or few days). The roaming data records can be associated with multiple countries globally (e.g., as shown in the map portion 402 in FIG. 4) and multiple roaming network operators of each of the multiple countries (e.g., Canada has three roaming network operators as shown by the data in portions 404, 408, 410, and 412).

In some implementations, accessing the roaming data records includes receiving, by a PGW (e.g., the PGW 308 in FIG. 3) of the telecommunications network, from SGWs (e.g., the SGW 312) of the roaming network operators, roaming data describing the data traffic volume. The accessing further includes receiving, by a repository (e.g., the repository 304), from the PGW, the roaming data and aggregating, by the repository, the roaming data into roaming data records based on the multiple countries and the multiple roaming network operators of each of the multiple countries. The accessing further includes retrieving the roaming data records by the system (e.g., the roaming data traffic management system 302 in FIG. 3) from the repository.

At 504, the system can determine, using the roaming data records for the period of time, country-specific deviation values for each of the multiple countries. In some implementations, the period of time is ranging from 10 days to 60 days (e.g., 10 days, 30 days, 45 days, 60 days). The roaming data records are accessed periodically every day. The deviation can represent a variability from an average or mean value measured over the period of time. The deviation values can include standard deviation (std dev). Alternatively, the deviation values can include variance, mean absolute deviation, mean squared error, or other similar deviation value. The country-specific deviation values can describe data traffic volume deviating from an average (or mean) data traffic volume for each of the respective countries.

At 506, the system can determine whether each of the country-specific deviation values satisfies a deviation threshold value (e.g., whether each of the country-specific deviation values is above or below the deviation threshold range). In some implementations, the threshold range is ±1 std dev, ±3 std dev, ±5 std dev, or ±10 std dev from the average roaming data volume over the comparison time period. In some implementations, the deviation threshold value is a metric value or a range of metric values. For example, the system can determine whether each of the country-specific deviation values satisfies a metric threshold value or is above or below a threshold value. A metric threshold value can be, for example, in units of bits per second.

Responsive to a determination that a particular country-specific value associated with a particular country is above or below the deviation threshold range, at 508, the system can categorize the particular country as an outlier country. An outlier country is likely experiencing some anomalies or irregularities with one or more of its roaming network operators, which causes abnormal activity in the roaming traffic flow. For example, one of the roaming networks in an outlier country might be experiencing congestion or interruption which causes roaming data traffic to be low for that network while other networks are experiencing a higher than normal data traffic. As another example, all roaming networks of an outlier country might have an increased or decreased roaming data traffic which causes a deviation. Such increased or decreased roaming data traffic can be associated with users travelling more or less to the outlier country, or, for example, opting to purchase local network services rather than using roaming data (e.g., due to lower cost). As yet another example, the interconnect can misconfigurate steering (e.g., by incorrect steering parameters that direct the roaming steering) that causes data packets to be misrouted to an unpreferred operator thereby reducing traffic to the preferred operator. Such misconfiguration can lead to unforeseen financial charges due to unnecessary traffic to the unpreferred operator.

At 510, the system can determine, using the roaming data records for the multiple roaming network operators, operator-specific deviation values for each roaming network operator of the particular country. The operator-specific deviation values provide further information regarding causes for the deviation and can be used to identify a particular roaming network operator that is causing the deviation for the outlier country.

At 512, the system can provide a GUI including a first GUI and a second GUI portion. The first GUI portion (e.g., the map portion 402 in FIG. 4) can include a geographical illustration of the particular country and one or more of the multiple countries over the period of time. The particular country identified as an outlier country can be indicated with an indication on the geographical illustration (e.g., the indicator 414). The second GUI portion (e.g., the graph portion 404) can illustrate data traffic volume for each roaming network operator of the particular country.

At 514, the system can determine, using the operator-specific deviation values for each roaming network operator of the particular country, that a particular roaming network operator is associated with an anomaly. As described, the anomaly can be associated with a roaming network operator having increased or decreased roaming data traffic, or possibly fluctuations in the data traffic (e.g., temporal congestion or interruption).

Responsive to a determination that the particular roaming network operator is associated with the anomaly, at 516, the system can enable the performance of a mitigating action. The mitigation action can include steering roaming between the network operators of the particular country to correct for the anomaly. Steering the roaming can include causing wireless devices accessing the particular roaming network operator to instead access other roaming network operators of the particular country. This can be performed by, for example, defining a default roaming network operator for the particular country to be different from the particular roaming network operator. Defining a default roaming network operator can include defining a default network access point (specific to a roaming network operator) as a wireless device enters a geographical area covered by roaming network operators. The steering can be also performed by setting parameters and/or thresholds for a wireless device to access a roaming network operator. A wireless device can be caused to access a roaming network operator based on parameters such as signal strength, load balancing, bandwidth, security standards and/or other network operating parameters. For example, in an instance that a signal strength of a network associated with the particular roaming operator is below a particular threshold, a wireless device can be caused to automatically access another roaming network.

In some implementations, steering the roaming within the network operators of the particular country to correct for the anomaly includes causing wireless devices accessing the particular roaming network operator to access other roaming network operators of the particular country. The steering can include, for example, changing the preferred or default roaming network operators for the wireless devices or steering certain type of data traffic (e.g., voice versus SMS versus data) to a particular roaming network operator over another operator.

In some implementations, the mitigating action further includes causing an evaluation (or re-negotiation) of a roaming contract between the particular roaming network operator and the service provider of the telecommunications network, causing evaluation of a network-to-network interconnector (e.g., the interconnector 306 in FIG. 3) between the particular roaming network operator and the service provider of the telecommunications network, or determining, using public information and/or information received from the particular roaming network operator, whether there is an occurrence of a planned (e.g., planned maintenance or modifications to network) or unplanned event (e.g., weather-related network interruptions) causing the anomaly. In some implementations, enabling the mitigating action includes creating an alert or a notification describing the anomaly and transmitting the alert or indication to a relevant system, sub-system, or party. As an example, in an instance that the mitigating action includes evaluating and/or re-negotiation of one or more roaming contracts, the system can create and transmit a notification regarding the anomaly to a sub-system of the telecommunications network service provider that is responsible for management of the roaming contracts to initiate such evaluation and/or re-negotiation. As another example, the system can create and transmit a notification regarding the anomaly to the relevant roaming operator (e.g., to indicate that their network services are experiencing congestion or interruptions). In some implementations, any of the mitigating actions can be performed automatically in response the determination that the particular roaming network operator is associated with the anomaly.

As an example, responsive to the determination that the particular roaming network operator is associated with the anomaly, the system determines, using public information and/or information received from the particular roaming network operator, that there is an occurrence of a planned or unplanned event causing the anomaly. Subsequent to a determination that the occurrence of the planned or unplanned event is over, the system can forgo any further steering of the roaming between the network operators of the particular country. A planned even can be associated with maintenance or reconstruction associated with the infrastructure of the roaming network operator. An unplanned even can be associated with an unexpected change in the environment that affects the infrastructure of the roaming network (e.g., weather or nature related incidence).

As another example, responsive to the determination that the particular roaming network operator is associated with the anomaly, the system causes evaluation of a roaming contract between the particular roaming network operator and the service provider of the telecommunications network. For example, the particular roaming network operator can have a higher cost compared to other roaming network operators of the particular country and increase in the data traffic can increase costs for the service provider of the telecommunications network. The service provider of the telecommunications network can initiate new negotiations in an effort to lower the cost.

As yet another example, responsive to the determination that the particular roaming network operator is associated with the anomaly, the system causes evaluation of a network-to-network interconnector between the particular roaming network operator and the service provider of the telecommunications network. The evaluation can include determining whether the interconnector operates in accordance with pre-determined protocols, as it should. In some instances the network-to-network interconnector is operated by an outside party (e.g., a vendor) and the evaluation includes requesting information regarding the operation of the interconnector from the outside party.

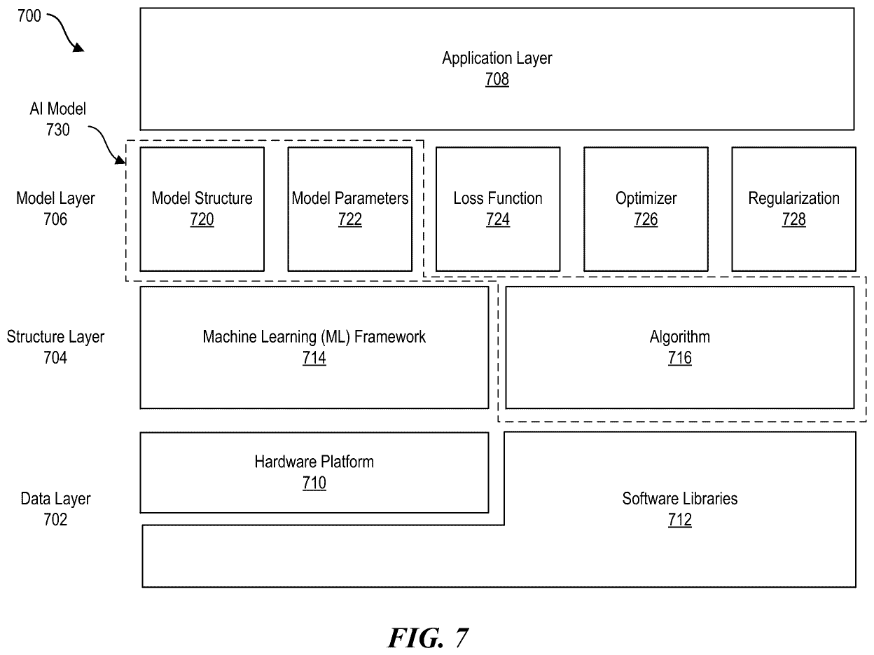

In some implementations, the system further validates, by an AI model using the roaming data records for the period of time, whether the particular roaming network operator is associated with the anomaly. The automatic steering of roaming within the network operators of the particular country can be performed in response to the validation. The AI model can also suggest further mitigation actions to be taken. The country-specific values and the operator-specific deviation values can be input to the AI model which is trained to predict, using this input, whether there is an existing or future anomaly. The AI model can be trained using training sets including historical country-specific and operator-specific deviation values and corresponding identified anomalies for the identified anomalies. In some implementations, the training sets can be specific for countries. For example, a model specific for Canada can be trained using historical deviation values related to Canadian operators and their respective anomalies. This can take into account country-specific features (e.g., country-specific weather conditions, geographical features, infrastructure related features, or country-specific costs). The AI model can provide further insight into causes for anomalies. For example, the AI model can be trained by using historical causes for anomalies and corresponding historic country-specific values and the operator-specific deviation values to predict causes for anomalies. Principles of an AI system for performing the validation are described with respect to FIG. 7.

In some implementations, for country-specific deviation values that are within the deviation threshold range, the system then determines whether each of such country-specific deviation values is above or below an additional deviation threshold range (e.g., whether a country has an increased or decreased roaming data traffic). Responsive to a determination that an additional country-specific value associated with an additional country is above or below the additional deviation threshold, the system can predict, by the AI model using the roaming data records for the period of time, whether an additional roaming network operator of the additional country is likely to be associated with an additional anomaly in the future. In some implementations, responsive to a prediction that the additional roaming network operator is likely to be associated with the additional anomaly, the system can automatically perform an action to prevent the additional anomaly. In some implementations, responsive to the determination that the additional country-specific value associated with the additional country is above or below the additional deviation threshold, the system modifies the first GUI portion to identify the additional country with an additional indication that is different from the indication associated with the outlier country. The additional country can be indicated on the map portion 404 of the GUI 400 in FIG. 4 with an indicator having a different appearance than an outlier country or a regular, non-deviating country.

In some implementations, subsequent to the steering of roaming within the network operators of the particular country to correct for the (initial) anomaly, the system re-determines whether the particular roaming network operator continues to be associated with the anomaly. Responsive to a determination that the particular roaming network operator continues to be associated with the anomaly, the system can perform an additional action to further mitigate the anomaly. The additional anomaly can be caused by a different or same reason as the initial anomaly, and the mitigating action can be the same or different as the mitigating action used to address the initial anomaly.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or include a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### AI System

FIG. 7 is a block diagram that illustrates an example of an AI system 700 in which at least some operations described herein can be implemented. As shown, the AI system 700 can include a set of layers, which conceptually organize elements within an example network topology for the AI system's architecture to implement a particular AI model 730. Generally, an AI model 730 is a computer-executable program implemented by the AI system 700 that analyzes data to make predictions. Information can pass through each layer of the AI system 700 to generate outputs for the AI model 730. The layers can include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for the application of the AI model 730 by the application layer 708.

The data layer 702 acts as the foundation of the AI system 700 by preparing data for the AI model 730. As shown, the data layer 702 can include two sub-layers: a hardware platform 710 and one or more software libraries 712. The hardware platform 710 can be designed to perform operations for the AI model 730 and include computing resources for storage, memory, logic, and networking, such as the resources described in relation to FIG. 5. The hardware platform 710 can process amounts of data using one or more servers. The servers can perform backend operations such as matrix calculations, parallel calculations, machine learning (ML) training, and the like. Examples of servers used by the hardware platform 710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 710 can include Infrastructure as a Service (IaaS) resources, which are computing resources (e.g., servers, memory, etc.), offered by a cloud services provider. The hardware platform 710 can also include computer memory for storing data about the AI model 730, application of the AI model 730, and training data for the AI model 730. The computer memory can be a form of random-access memory (RAM), such as dynamic RAM, static RAM, and non-volatile RAM.

The software libraries 712 can be thought of as suites of data and programming code, including executables, used to control the computing resources of the hardware platform 710. The programming code can include low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource's instruction set architecture, allowing them to run quickly with a small memory footprint.

The structure layer 704 can include an ML framework 714 and an algorithm 716. The ML framework 714 can be thought of as an interface, library, or tool that allows users to build and deploy the AI model 730. The ML framework 714 can include an open-source library, an Application Programming Interface (API), a gradient-boosting library, an ensemble method, and/or a deep learning toolkit that work with the layers of the AI system to facilitate the development of the AI model 730. For example, the ML framework 714 can distribute processes for the application or training of the AI model 730 across multiple resources in the hardware platform 710. The ML framework 714 can also include a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730.

The algorithm 716 can be an organized set of computer-executable operations used to generate output data from a set of input data and can be described using pseudocode. The algorithm 716 can include complex code that allows the computing resources to learn from new input data and create new/modified outputs based on what was learned. In some implementations, the algorithm 716 can build the AI model 730 through being trained while running computing resources of the hardware platform 710. This training allows the algorithm 716 to make predictions or decisions without being explicitly programmed to do so. Once trained, the algorithm 716 can run at the computing resources as part of the AI model 730 to make predictions or decisions, improve computing resource performance, or perform tasks. The algorithm 716 can be trained using supervised learning, unsupervised learning, semi-supervised learning, and/or reinforcement learning.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A computer-implemented method for managing roaming data traffic in a telecommunications network, the method comprising:
accessing roaming data records comprising information of data traffic volume by multiple wireless devices associated with a service provider of the telecommunications network accessing any wireless networks that are different from the telecommunications network,
wherein the roaming data records represent a period of time, and
wherein the roaming data records are associated with multiple countries and multiple roaming network operators of each of the multiple countries;
determining, using the roaming data records for the period of time, country-specific deviation values for each of the multiple countries,
wherein the country-specific deviation values describe data traffic volume deviating from an average data traffic volume for each of the respective countries;
determining whether each of the country-specific deviation values is above or below a deviation threshold range;
responsive to a determination that a particular country-specific value associated with a particular country of the multiple countries is above or below the deviation threshold range,
categorizing the particular country as an outlier country; and
determining, using the roaming data records for the multiple roaming network operators, operator-specific deviation values for each roaming network operator of the particular country;
providing a graphical user interface (GUI) comprising a first GUI portion and a second GUI portion,
wherein the first GUI portion comprises a geographical illustration of the particular country and one or more of the multiple countries over the period of time,
wherein the particular country is identified as an outlier country via an indication on the geographical illustration; and
wherein the second GUI portion illustrates data traffic volume for each of the multiple roaming network operators of the particular country;
determining, using the operator-specific deviation values for each roaming network operator of the particular country, that a particular roaming network operator is associated with an anomaly; and
responsive to a determination that the particular roaming network operator is associated with the anomaly, enabling performance of a mitigating action comprising steering roaming to correct for the anomaly,
wherein steering the roaming comprises causing wireless devices accessing the particular roaming network operator to instead access other roaming network operators of the particular country.

2. The computer-implemented method of claim 1, wherein accessing the roaming data records comprises:
receiving, by a packet data network gateway (PGW) of the telecommunications network from serving gateways (SGWs) of the
roaming network operators, roaming data describing the data traffic volume;
receiving, by a repository from the PGW, the roaming data; and
aggregating, by the repository, the roaming data into roaming data records based on the multiple countries and the multiple roaming network operators of each of the multiple countries.

3. The computer-implemented method of claim 1, further comprising:
validating, by an artificial intelligence (AI) model using the roaming data records for the period of time, whether the particular roaming network operator is associated with the anomaly,
wherein the steering of the roaming within the network operators of the particular country is performed in response to the validation.

4. The computer-implemented method of claim 1, further comprising:
for country-specific deviation values that are within the deviation threshold range,
determining whether each of such country-specific deviation values is above or below an additional deviation threshold range; and
responsive to a determination that an additional country-specific value associated with an additional country is above or below the additional deviation threshold, 'predicting, by an artificial intelligence (AI) model using the roaming data records for the period of time, whether an additional roaming network operator of the additional country is likely to be associated with an additional anomaly.

5. The computer-implemented method of claim 4, further comprising:
responsive to a prediction that the additional roaming network operator is likely to be associated with the additional anomaly,
automatically performing an action to prevent the additional anomaly.

6. The computer-implemented method of claim 4, further comprising:
responsive to the determination that the additional country-specific value associated with the additional country is above or below the additional deviation threshold,
modifying the first GUI portion to identify the additional country with an additional indication that is different from the indication associated with the outlier country.

7. The computer-implemented method of claim 1, further comprising:
subsequent to the steering of roaming within the network operators of the particular country to correct for the anomaly,
re-determining whether the particular roaming network operator continues to be associated with the anomaly; and
responsive to a determination that the particular roaming network operator continues to be associated with the anomaly, performing an additional action to further mitigate the anomaly.

8. The computer-implemented method of claim 1,
wherein the mitigating action further comprises causing an evaluation of a roaming contract between the particular roaming network operator and the service provider of the telecommunications network, causing evaluation of a network-to-network interconnector between the particular roaming network operator and the service provider of the telecommunications network, or determining, using public information and/or information received from the particular roaming network operator, whether there is an occurrence of a planned or unplanned event causing the anomaly.

9. The computer-implemented method of claim 1, further comprising:
determining, using public information and/or information received from the particular roaming network operator, that there is an occurrence of a planned or unplanned event causing the anomaly; and
subsequent to a determination that the occurrence of the planned or unplanned event is over, forgoing any further steering of the roaming within the network operators of the particular country.

10. The computer-implemented method of claim 1, further comprising:
responsive to the determination that the particular roaming network operator is associated with the anomaly,
causing evaluation of a roaming contract between the particular roaming network operator and the service provider of the telecommunications network.

11. The computer-implemented method of claim 1, further comprising:
responsive to the determination that the particular roaming network operator is associated with the anomaly,
causing evaluation of a network-to-network interconnector between the particular roaming network operator and the service provider of the telecommunications network.

12. The computer-implemented method of claim 1,
wherein the period of time is ranging from 30 days to 60 days, and
wherein the roaming data records are collected periodically every day.

13. The computer-implemented method of claim 1,
wherein enabling the performance of the mitigation action comprises creating an alert or an indication describing the anomaly.

14. A system for managing roaming data traffic in a telecommunications network, the system comprising:
at least one hardware processor; and
at least one non-transitory memory storing instructions, which, when executed by the at least one hardware processor, cause the system to:
access roaming data records,
wherein the roaming data records comprise information of data traffic volume by multiple wireless devices associated with a service provider of the telecommunications network accessing any wireless networks that are different from the telecommunications network,
wherein the roaming data records are associated with a set of countries and a set of roaming network operators of each of the set of countries;
determine, using the roaming data records, country-specific deviation values for each of the set of countries,
wherein the country-specific deviation values describe data traffic volume deviating from an average data traffic volume for each of the respective countries;
determine whether each of the country-specific deviation values satisfy a deviation threshold range;
responsive to a determination that a particular country-specific value associated with a particular country of the set of countries is above or below the deviation threshold range,
categorize the particular country as an outlier country; and
determine, using the roaming data records for the set of roaming network operators, operator-specific deviation values for each roaming network operator of the particular country;
determine, using the operator-specific deviation values for each roaming network operator of the particular country, that a particular roaming network operator is associated with an anomaly; and
responsive to a determination that the particular roaming network operator is associated with the anomaly, enable performance of a mitigating action to correct for the anomaly.

15. The system of claim 14, wherein the system is further caused to:
validate, by an artificial intelligence (AI) model using the roaming data, whether the particular roaming network operator is associated with the anomaly, wherein the mitigating action is performed in response to the validation.

16. The system of claim 14, wherein the system is further caused to:
for country-specific deviation values that are within the deviation threshold range,
determine whether each of such country-specific deviation values is above or below an additional deviation threshold range;
responsive to a determination that an additional country-specific value associated with an additional country is above or below the additional deviation threshold,
predict, by an artificial intelligence (AI) model using the roaming data records, whether an additional roaming network operator of the additional country is likely associated with an additional anomaly.

17. The system of claim 14,
wherein the mitigating action includes steering roaming within the network operators of the particular country to correct for the anomaly, causing an evaluation of a roaming contract between the particular roaming network operator and the service provider of the telecommunications network, causing evaluation of a network-to-network interconnector between the particular roaming network operator and the service provider of the telecommunications network, or determining, using public information and/or information received from the
particular roaming network operator, whether there is an occurrence of a planned or unplanned event causing the anomaly.

18. A non-transitory, computer-readable storage medium comprising instructions recorded thereon, wherein the instructions, when executed by at least one data processor of a system, cause the system to:
access roaming data records,
wherein the roaming data records comprise information of data traffic volume by multiple wireless devices associated with a service provider of a telecommunications network accessing any wireless networks that are different from the telecommunications network,
wherein the roaming data records are associated with a set of countries and set of roaming network operators of each of the set of countries;
determine, using the roaming data records, country-specific deviation values for each of the set of countries,
wherein the country-specific deviation values describe data traffic volume deviating from an average data traffic volume for each of the respective countries;
determine whether each of the country-specific deviation values satisfy a deviation threshold range;
responsive to a determination that a particular country-specific value associated with a particular country of the set of countries is above or below the deviation threshold range,
categorize the particular country as an outlier country; and
determine, using the roaming data records for the set of roaming network operators, operator-specific deviation values for each roaming network operator of the particular country;
determine, using the operator-specific deviation values for each roaming network operator of the particular country, that a particular roaming network operator is associated with an anomaly; and
responsive to a determination that the particular roaming network operator is associated with the anomaly, enable performance of a mitigating action to correct for the anomaly.

19. The non-transitory, computer-readable storage medium of claim 18, wherein the system is further caused to:
for country-specific deviation values that are within the deviation threshold range,
determine whether each of such country-specific deviation values is above or below an additional deviation threshold range;
responsive to a determination that an additional country-specific value associated with an additional country is above or below the additional deviation threshold,
predict, by an artificial intelligence (AI) model using the roaming data records, whether an additional roaming network operator of the additional country is likely associated with an additional anomaly.

20. The non-transitory, computer-readable storage medium of claim 18,
wherein the mitigating action includes steering roaming between the network operators of the particular country to correct for the anomaly, causing an evaluation of a roaming contract between the particular roaming network operator and the service provider of the telecommunications network, causing evaluation of a network-to-network interconnector between the particular roaming network operator and the service provider of the telecommunications network, or determining, using public information and/or information received from the particular roaming network operator, whether there is an occurrence of a planned or unplanned event causing the anomaly.
